(19) United States
(12) Patent Application Publication
(10) Pub. No.: US 2019/0256678 A1
(43) Pub. Date: Aug. 22, 2019

(54) HYBRID AEROGELS BASED ON CLAYS

(71) Applicants: Henkel IP & Holding GmbH, Duesseldorf (DE); Henkel AG & Co. KGaA, Duesseldorf (DE)

(72) Inventors: Sergi Bassaganas Turon, Olot (ES); Chou Kang Wei, Sabadell (ES); Fouad Salhi, Farmington, CT (US); Maria Tome Jorge, Barcelona (ES); Florencia Cecchi, Barcelona (ES); Izaskun Miguel Garcia, Alfaz DelPi (ES); Belen Del Sazorozco, Las Rozas de Madrid (ES); Elisabet Torres Cano, Barcelona (ES); Ilaria De Santo, Naples (IT)

(21) Appl. No.: 16/251,910

(22) Filed: Jan. 18, 2019

Related U.S. Application Data
(63) Continuation of application No. PCT/EP2017/061717, filed on May 16, 2017.

(30) Foreign Application Priority Data
May 19, 2016 (EP) 16170380.6

(51) Int. Cl. C08J 9/00; C08G 83/00; C08J 9/28; C08G 18/79; C08G 18/38

(52) U.S. Cl. CPC C08J 9/0066; C08G 83/001; C08J 9/28; C08G 18/795; C08G 18/3895; C08G 2101/0091; C08J 2205/026; C08J 2375/04; C08G 2330/00; C08G 2350/00; C08J 2201/0502

(57) ABSTRACT

The present invention relates to a hybrid aerogel obtained by reacting an aromatic or aliphatic isocyanate compound and silanol moieties on a surface of a clay in a presence of a solvent. Hybrid aerogels according to the present invention provide high thermal insulation material, while good mechanical properties and performance is maintained.

### TECHNICAL FIELD

The present invention relates to hybrid aerogels obtained by reacting an isocyanate compound and silanol moieties on a surface of a clay in a presence of a solvent. The hybrid aerogels according to the present invention provide high thermal insulation materials, while maintaining good mechanical properties.

### BACKGROUND OF THE INVENTION

Aerogels are three-dimensional, low-density solid network structures derived from drying wet-gels by exchanging the pore-filling solvent to a gas, usually with a supercritical fluid. By these means, the capillary forces exerted by the solvent due to evaporation are minimized, and structures with large internal void space on the nanometric range are achieved. The high porosity and the small pore size of these materials is the reason for their very low thermal conductivity, which makes aerogels extremely attractive materials for thermal insulating applications.

Thermal insulation is important in many different applications in order to save energy and reduce costs. Examples of such applications are construction, transport and industry. For some applications, it is possible to use a thick insulating panel to reduce the heat transfer. However, other applications may require thinner insulating panels and/or layers because of size limitations. For the thin insulating panels/layers the thermal conductivity of the material has to be lower in order to get the same insulating properties than with thicker insulating panels and/or layers. Additionally, in some cases and depending on the application, high mechanical properties may also be required.

Compared to common thermal insulators in the market, aerogels are lightweight materials with a very low thermal conductivity due to their nanostructure and the reduction of the contribution to thermal conductivity from the gas phase. Thus, thickness of the insulating layer can be reduced while obtaining similar insulating properties.

Most of known aerogels are inorganic aerogels, which are mainly based on silica. Despite their high thermal insulating properties, a slow commercialization has been observed due to their fragility and poor mechanical properties. This fragility may be overcome by different methods. For example, by cross-linking aerogels with organic polymers or by post-gelation casting of a thin conformal polymer coating over the entire internal porous surface of the preformed wet-gel nanostructure. Moreover, inorganic aerogels are brittle, dusty and easy air-borne, and therefore, cannot withstand mechanical stress. Because of that, sometimes they are classified as hazardous materials. In addition, due to their brittleness, they are not suitable for some applications where mechanical properties are required.

On the other hand, different organic aerogels have also been described in the literature. These materials are generally based on polymeric networks of different nature, formed by cross-linking of monomers in a solution to yield a gel, which is subsequently dried to obtain a porous material. Organic aerogels are robust and mechanically stable, which is an advantage for many applications. However, some of these materials can also have drawbacks.

First organic aerogels described in the literature were based on phenol-formaldehyde resins, which can also be used to prepare carbon aerogels by pyrolysis. Resorcinol-formaldehyde aerogels are brittle and their curing process takes a long time (up to 5 days), which results a drawback for an industrial scale production. Other significant organic aerogels are based on materials prepared using polyfunctional isocyanates, which have faster curing processes, and their mechanical properties can be modified. Mechanical properties depend on the reacting functional group with the isocyanate moiety, as well as the monomer and/or oligomer chemical structure (i.e. number of functionalities, aromatic or aliphatic nature, steric hindrance, etc.).

Recently there have been approaches to use clays as a silica replacement, because they are an inexpensive silica source. Moreover, the large aspect ratio that comes from clays' unique morphology is responsible for the enhancement of many properties compared to conventional inorganic fillers, like barrier properties, flammability resistance, strengthen of mechanical properties in two directions, membrane properties and polymer blend compatibilization.

Clays are naturally hydrophilic and they are organized in a layered structure. They are optimal for the preparation of pure clay-aerogels by lyophilization, due to the water molecules contained in-between the inorganic layers. Generally, ambient evaporation is avoided, since it induces high shrinkage in the dried aerogel material. For this reason, clay-based aerogels are usually prepared in water or alcoholic mixtures. This is due to the high melting points (−130-0° C.) of water and alcohols compared to other organic solvents. Furthermore, they are easy to freeze and to lyophilize afterwards. The layers of the clay, upon freezing and subsequent lyophilization, result in aerogels with low-density structure. However, it is expected that these materials are very brittle, because of the lack of crosslinking within the clay structure. Besides lyophilization, other subcritical drying methods are described in the literature and include running temperature cycles, vacuum and microwaves cycles.

Literature describes different types of clay based aerogels. First type is the pure clay aerogels, which are described above, and which are exclusively made out of clays. This approach is focused on using the layered structure of clays to replace the interstitial water contained in-between the layers for a gas, resulting in a pure clay-based aerogel. However, this procedure is limited to non-modified clays and water or alcoholic mixtures as solvents. In addition, the drying process of lyophilization, represents a drawback for the materials obtained due to the impossibility of controlling the pore structure. Second type is clay aerogel composites. Different methods to obtain clay aerogel composites are described in the literature. For example, a previously prepared pure-clay aerogel can be embedded in a polymer matrix, or in a monomer mixture that is post polymerized. On the contrary, the clay may be first mixed with monomers or polymers, and the composite aerogel is formed subsequently. In these cases, the electrostatic interactions between the polymer and the clay lead to the formation of a composite material with enhanced properties, like reinforced matrixes. The processes relating to clay composites are limited to non-modified clays and polymers (or monomers) soluble in water or alcohol mixtures and drying processes like lyophilisation. Third type is aerogels having clays used as fillers. Due to the low cost of clays, their high abundance and their high surface area, they can also be used as fillers in organic aerogels. Fourth type is hybrid-clay aerogels. These hybrid aerogels are based on chemical linkages, which connect the material and the clay platelets.

Therefore, there is still a need for further hybrid aerogels having improved thermal conductivity and mechanical properties.

### SUMMARY OF THE INVENTION

The present invention relates to a hybrid aerogel obtained by reacting an isocyanate compound and silanol moieties on a surface of a clay in a presence of a solvent, wherein said isocyanate compound is an aromatic isocyanate compound or an aliphatic isocyanate compound selected from the group consisting of

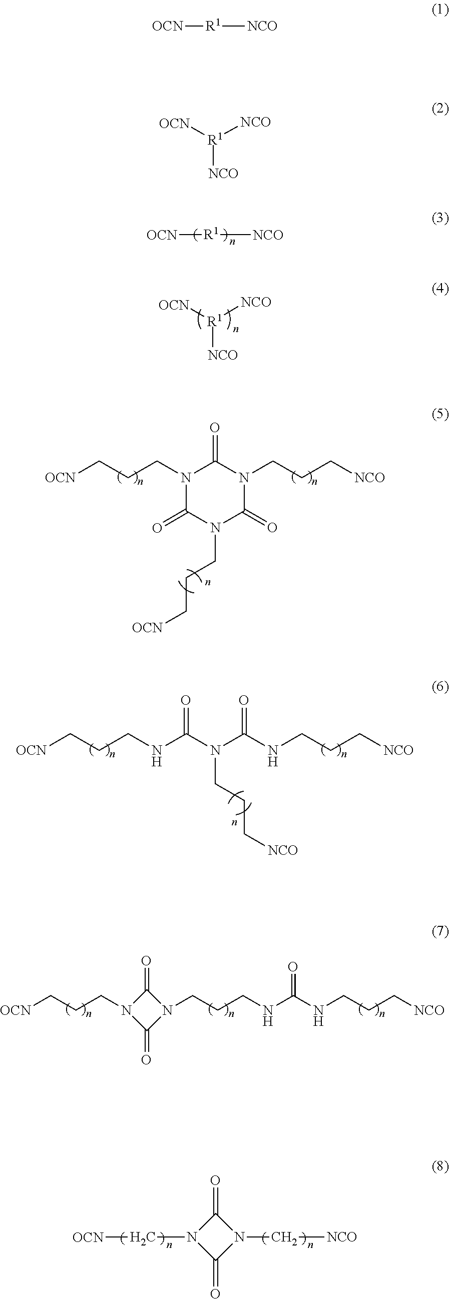

wherein R¹ is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and an integer n is from 1 to 30;

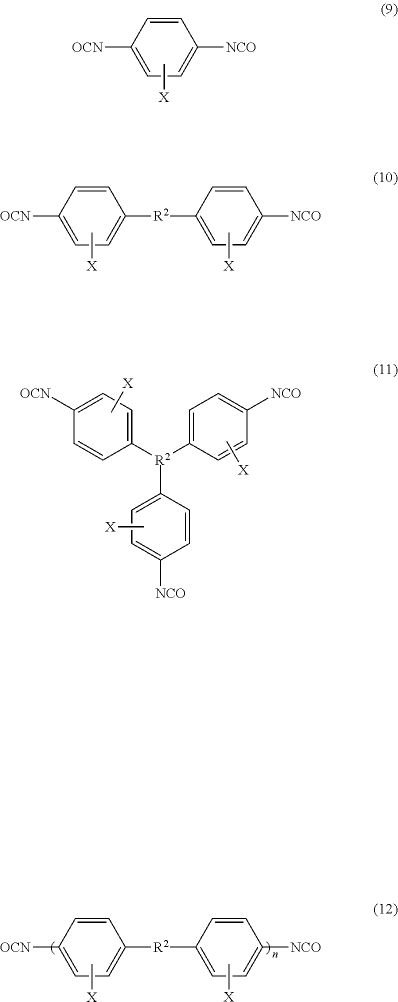

wherein X represents a substituent, or different substituents and are selected independently from the group consisting of hydrogen, halogen and linear or branched C1-C6 alkyl groups, attached on their respective phenyl ring at the 2-position, 3-position or 4-position, and their respective isomers, and R² is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3 to C30 heterocycloalkyl group and a substituted or unsubstituted C1-C30 heteroalkyl group from and a combination of thereof; and an integer n is from 1 to 30;

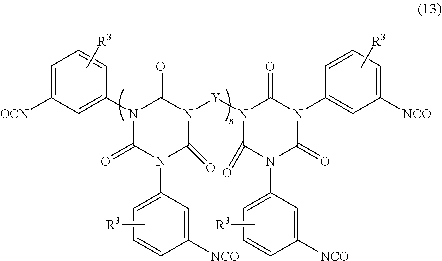

wherein R³ is selected independently from the group consisting of alkyl, hydrogen and alkenyl, and Y is selected from the group consisting of

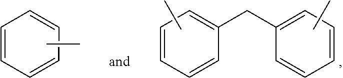

and n is an integer from 0 to 3;

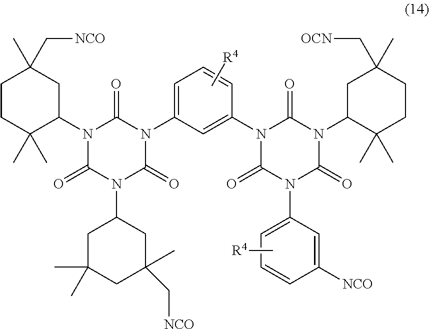

wherein R⁴ is selected independently from the group consisting of alkyl, hydrogen and alkenyl.

The present invention also relates to a method for preparing an aerogel according to the present invention comprising the steps of: 1) adding a clay into a solvent and mixing at high shear rates; 2) adding an isocyanate and mixing; 3) adding a catalyst if present, and mixing; 4) letting the mixture to stand in order to form a gel; 5) washing said gel with a solvent; and 6) drying said gel by supercritical drying or ambient drying.

The present invention encompasses a thermal or an acoustic insulating material comprising a hybrid aerogel according to the present invention.

In addition, the present invention encompasses the use of a hybrid aerogel according to the present invention as a thermal or acoustic insulating material.

### DESCRIPTION OF THE FIGURES

FIG. 1 illustrates a basic principle of the reaction between the isocyanate compound and silanol moieties to obtain a hybrid aerogel according to the present invention.

FIG. 2 illustrates a structure of an organoclay.

FIG. 3 illustrates the delamination of the clays when dispersed in a compatible solvent.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

All percentages, parts, proportions and then like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in disclosing the invention, including technical and scientific terms, have the meaning as commonly understood by one of the ordinary skill in the art to which this invention belongs to. By means of further guidance, term definitions are included to better appreciate the teaching of the present invention.

The aerogels according to the present invention are hybrid aerogels. By the term “hybrid aerogel” is meant herein an aerogel, which is made by combining inorganic and organic elements. More specifically, a hybrid aerogel according to the present invention is prepared from both an inorganic component and an organic monomer, wherein the final structure is an inorganic-organic cross-linked network as a result of the chemical reaction between both components.

The present invention relates to a method to prepare crosslinked hybrid aerogels. The present invention provides a material containing inorganic particles, avoiding the problems associated to dusty silica. In the process according to the present invention, the silanol moieties (Si—OH) on the surface of the clay react with isocyanate monomers to produce an inorganic-organic crosslinked gel structure to obtain low-density materials. In other words, the clay is chemically bonded to the organic polymer, actually forming part of the polymer backbone and therefore, part of the 3D network. The hybrid-clay aerogel according to the present invention combines both good thermal insulation and mechanical properties. The hybrid aerogels according to the present invention provide an improvement in terms of mechanical properties compared to clay-aerogels described in the literature. They also reduce the issues related to breathable nanoparticles of the final material compared to the currently commercialized materials. This is due the fact that the clays form a part of the aerogel network, and are linked together through the organic flexible bridges, leading to a robust final material with no or minimized dustiness.

Furthermore, the reaction medium of the present invention does not require neither water nor alcoholic mixtures exclusively, but any type of organic solvent may be used, ranging from non-polar to polar.

A hybrid aerogel according to the present invention is obtained by reacting an isocyanate compound and silanol moieties on a surface of a clay. FIG. 1 illustrates the basic principle of this reaction.

Due to the reactivity of isocyanate moieties, the resulting low-density network includes polyurethane components but it may also include polyurea and polyisocyanurate components, however, in a lesser extent. This depends on the nature of the starting isocyanate and reaction conditions. Polyisocyanurate formation is minimized in the present invention, because this reaction is favoured at high temperatures, and the hybrid aerogels are prepared at room temperature. Nevertheless, competition between urethane and urea could still occur. Characterization of the hybrid aerogels can be carried out by FTIR and solid ¹³C-NMR in order to verify the main composition of the final material. The results of the present invention show that there is a high degree of crosslinking between the clays and the polymer matrix.

Suitable isocyanate compound for use in the present invention is an aromatic isocyanate compound or an aliphatic isocyanate compound.

Suitable aliphatic isocyanate compound for use in the present invention is selected from the group consisting of

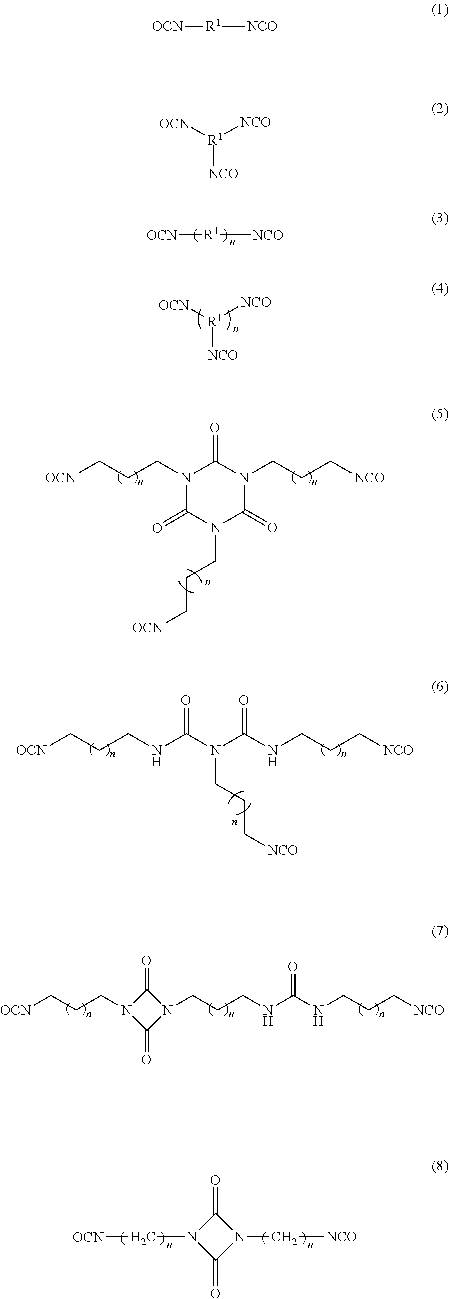

wherein R¹ is selected from the group consisting of a single bonded —O—, —S—, —CO(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and an integer n is from 1 to 30.

Suitable aromatic isocyanate compound for use in the present invention is selected from the group consisting of

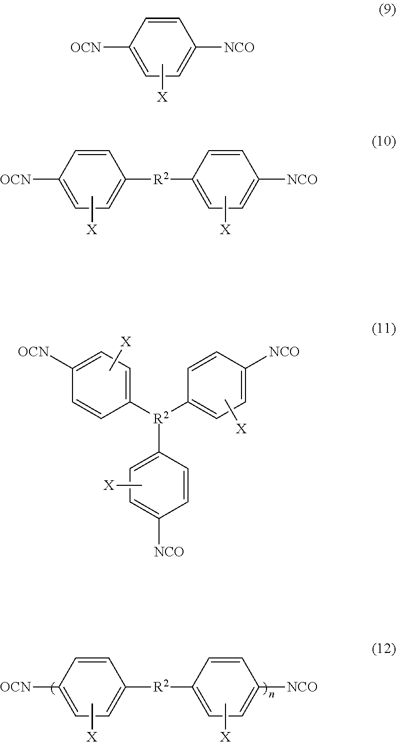

wherein X represents a substituent, or different substituents and are selected independently from the group consisting of hydrogen, halogen and linear or branched C1-C6 alkyl groups, attached on their respective phenyl ring at the 2-position, 3-position or 4-position, and their respective isomers, and R² is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3 to C30 heterocycloalkyl group and a substituted or unsubstituted C1-C30 heteroalkyl group from and a combination of thereof; and an integer n is from 1 to 30;

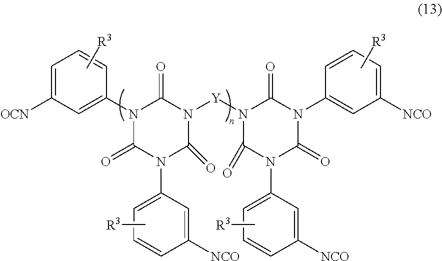

wherein R³ is selected independently from the group consisting of alkyl, hydrogen and alkenyl, and Y is selected from the group consisting of

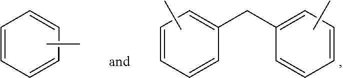

and n is an integer from 0 to 3;

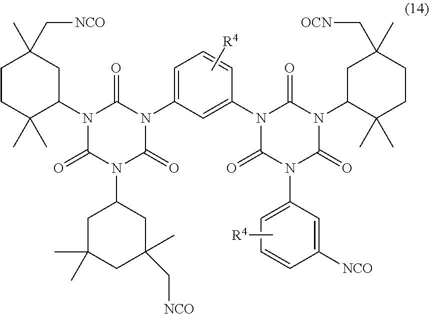

wherein R⁴ is selected independently from the group consisting of alkyl, hydrogen and alkenyl.

Preferably, the isocyanate compound is selected from the group consisting of 1,3,5-tris(6-isocyanatohexyl)-1,3,5-triazinane-2,4,6-trione, 6-[3-(6-isocyanatohexyl)-2,4-dioxo-1,3-diazetidin-1-yl]hexyl N-(6-isocyanatohexyl) carbamate, methylene diphenyl diisocyanate, 1,6-diisocyanatohexane, 1-[bis(4-isocyanatophenyl)methyl]-4-isocyanatobenzene, 2,4-diisocyanato-1-methyl-benzene, oligomers of the above-mentioned and mixtures thereof.

Preferred isocyanates provide a high crosslinking degree, fast gelling times, gelation at ambient conditions and homogeneous materials.

Suitable commercially available isocyanates for use in the present invention include, but are not limited to Desmodur N3300, Desmodur N3200, Desmodur RE, Desmodur HL, Desmodur IL available from Bayer; Polurene KC and Polurene HR from Sapici, methylene diphenyl diisocyanate (MDI), toluylene diisocyanate (TDI) and hexamethylene diisocyanate (HDI) from Sigma Aldrich.

A hybrid aerogel according to the present invention has an isocyanate content from 1 to 60% by weight of the weight of the initial solvent, preferably from 2 to 40%, and more preferably from 5 to 25%.

A hybrid aerogel according to the present invention is obtained by reacting an isocyanate compound and silanol moieties on a surface of a clay.

Clays have a high impact in the final material properties, especially when they are in a delaminated state, as a very high aspect ratio is achieved. In this way, the tortuosity is increased (the diffusion path of molecules is highly altered), and therefore, the mass and heat transport rates within the material are reduced. Additionally, properly dispersed and aligned clay platelets have proven to be very effective for increasing stiffness. Therefore, hybrid clay based aerogels can combine both advantages from inorganic and organic materials. Low thermal conductivity as well as good mechanical properties are kept, while dustiness, one of the major drawbacks of silica aerogels, is minimized.

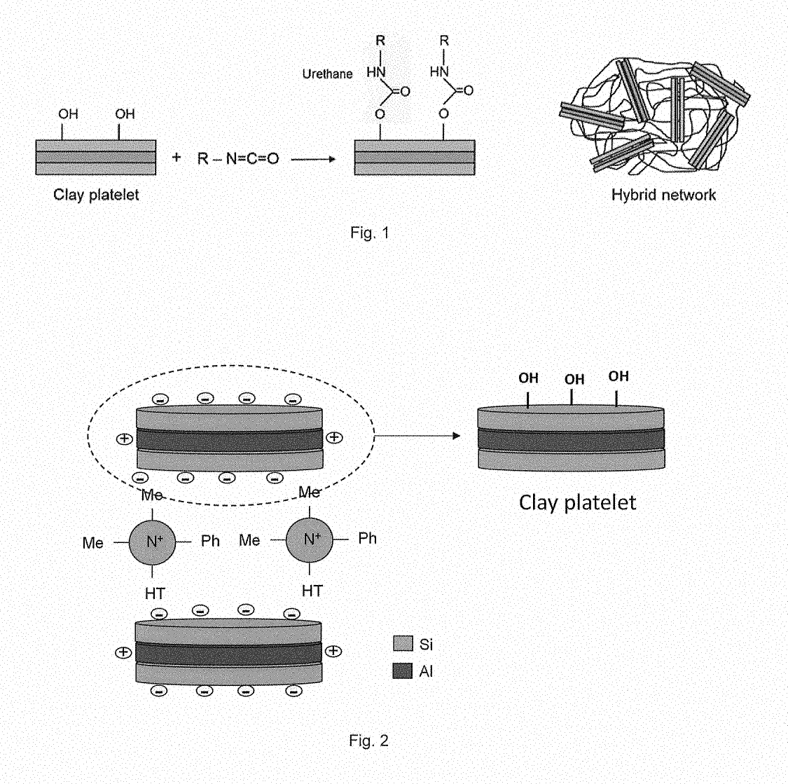

Clays are a class of aluminosilicate minerals that are naturally hydrophilic. They contain several aluminosilicate platelets. Each platelet is formed by two silicate layers with an aluminium oxide layer sandwiched in between. Some aluminium atoms are replaced by magnesium, generating a global negative charge. Small ions such as Na⁺, K⁺, Ca²⁺, etc., stay in the gallery between the platelets, counter-balancing the charge. In organoclays, these cations consist on quaternary ammonium salts with hydrocarbon substituents. FIG. 2 illustrates the structure of an organoclay. The aspect ratio of each platelet is very high. The lateral dimensions are in the micron size range, whereas the thickness is about one nanometer. The strong electrostatic interactions stack the platelets together forming aggregates and tactoids.

When clays are put in contact with solvents or polymers, two main situations can be obtained: 1) intercalation, wherein the solvent or the polymer is located in between two different platelets; 2) delamination, where platelets are exfoliated and dispersed in a continuous solvent or polymer matrix. In order to favour delamination in the presence of solvents or hydrophobic polymers, clays can be organically modified. In such organoclays, the intergallery cations are replaced by quaternary alkyl ammoniums, increasing their compatibility with organic systems.

According to the present invention, to achieve the hybrid network formed by the reaction between the silanol groups located on the surface of the clay and isocyanate groups, the clays must be delaminated prior to the reaction. Delamination allows the silanol groups confined in-between the agglomerated platelets to react with isocyanates. Therefore, dispersion and delamination is a key step during the process in order to achieve the final aerogel. Moreover, only when a high degree of delamination is achieved the enhancement in the properties of the final material due to the presence of clays, is observed.

The clays suitable for use in the present invention are mainly organically-modified, in order to enhance clays' compatibility with non-aqueous media. However, non-modified clays also provide hybrid aerogels in some non-aqueous solvents.

In the hybrid aerogels according to the present invention, the clay itself is promoting the formation of a strong 3D network of the hybrid aerogel through the crosslinking bridges. In order to get the proper supramolecular interaction to direct the gel formation, a good compromise between the clay, the reactive isocyanate, the solid content and the solvent needs to be carefully designed.

Suitable clays for use in the present invention are phyllosilicate mineral species. Preferably, suitable clay is selected from the group consisting of 2:1 laminar silicates, and more preferably from the subgroup of montmorillonite or sepiolite and mixtures thereof.

In a highly preferred embodiment, the clay is quaternary ammonium alkyl and/or aryl organically modified clay.

Preferred clays have a good dispersion and good solvent compatibility, which leads to homogeneous materials.

Examples of commercially available clays for use in the present invention are but not limited to Tixogel VZ, Tixogel MPZ, Tixogel VP, Tixogel MP250, Cloisite 30B, Cloisite 10A, Cloisite 15, Cloisite 20, Cloisite 93, Cloisite 116, Optigel CL, Claytone AF, Claytone 40, Laponite EP, Laponite B, Laponite RD, Laponite RDS and Garamite 1958 from BYK; Nanocor 130P and Nanocor PGN from Nanocor; Pangel S9, Pangel W, Pangel 20B, Pangel 40B Pansil 400 from Tolsa.

A hybrid aerogel according to the present invention has a clay content from 0.5 to 30% by weight of the weight of the initial solvent, preferably from 0.5 to 20% and more preferably from 0.5 to 10%.

A hybrid aerogel according to the present invention is formed in the presence of a solvent. The isocyanate compound will react with water and alcohols, and therefore, water and alcohols are not suitable solvents for use in the method according to the present invention. In order to obtain the desired hybrid network, it is necessary to disperse the clays in an organic solvent that could be polar or non-polar, but aprotic. Organically modified clays and high shearing mixing conditions are used in the present invention to improve the compatibility of the clays with suitable organic solvents.

Suitable solvent for use in the present invention is selected from the group consisting of a polar aprotic solvent, a non-polar solvent and mixtures thereof.

Preferably, the solvent is selected from the group consisting of dimethylacetamide (DMAc), dimethylformamide (DMF), tetrahydrofuran (THF), 1-methyl-2-pyrrolidinone (NMP), dimethyl sulfoxide (DMSO), acetonitrile, ethyl acetate, acetone, methyl ethyl ketone (MEK), methyl isobutyl ketone (MIBK), toluene, chloroform, benzene, xylene, hexane and mixtures thereof.

Clay, isocyanate and any optional ingredient quantities depend on the initial solvent quantity. As an example, in order to form an hybrid aerogel according to the present invention from batch of 1 l of solvent such as acetone—3.9-235 g of clay (0.5-30 wt %) and 7.9-474 g of isocyanate (1-60 wt %) are used.

In one embodiment, a hybrid aerogel according to the present invention is produced by reacting isocyanate compound and clay in the presence of a catalyst.

Suitable catalyst for use in the present invention is selected from the group consisting of alkyl amines, aromatic amines, imidazole derivatives, tin derivatives, aza compounds, guanidine derivatives, amidines and mixtures thereof.

Preferably, the catalyst is selected from the group consisting of triethylamine, trimethylamine, benzyldimethylamine (DMBA), N,N-dimethyl-1-phenylmethanamine, 1,4-diazabicyclo[2.2.2]octane, 2-ethyl-4-methylimidazole, 2-phenylimidazole, 2-methylimidazole, 1-methylimidazole, 4,4′-methylene-bis(2-ethyl-5-methylimidazole), 3,4,6,7,8,9-hexahydro-2H-pyrimido[1,2-a]pyrimidine, 2,3,4,6,7,8,9,10-octahydropyrimido [1,2-a]azepine, 1,8-diazabicyclo[5.4.0]undec-7-ene (DBU), 1,5,7-triazabicyclo[4.4.0]dec-5-ene (TBD), 1,4-diazabicyclo[2.2.2]octane, 1,5-diazabicyclo[4.3.0]non-5-ene, quinuclidine, dibutyltin dilaurate (DBTDL) and mixtures thereof.

Catalyst content in the reaction according to the present invention, when present, is from 0.01 to 20% by weight of the total weight of the initial solvent, preferably from 0.1 to 15% and more preferably from 0.1 to 5%.

A hybrid aerogel according to the present invention may further comprise at least one reinforcement, wherein said reinforcement is selected from the group consisting of fibres, particles, non-woven and woven fibre fabrics, 3D structures and mixtures thereof.

Non-limiting examples of suitable fibres are cellulose, aramid, carbon, glass and lignocellulosic fibres.

Non-limiting examples of suitable particles are carbon black, microcrystalline cellulose, silica, cork, lignin, and aerogel particles.

Non-limiting examples of suitable fibre fabrics are non-woven and woven glass, aramid, carbon and lignocellulosic fibre fabrics.

Non-limiting examples of suitable 3D structures are aramid fibre-phenolic, glass fibre-phenolic, polycarbonate and polypropylene honeycomb cores.

In a preferred embodiment at least one reinforcement is selected from the group consisting of cellulose fibres, aramid fibres, carbon fibres, glass fibres, lignocellulosic fibres, carbon black, microcrystalline cellulose, silica particles, cork particles, lignin particles, aerogel particles, non-woven and woven glass fibre fabrics, aramid fibre fabrics, carbon fibre fabrics, jute fibre fabrics, flax fibre fabrics, aramid fibre-phenolic honeycomb, glass fibre-phenolic honeycomb, polycarbonate core, polypropylene core, and mixtures thereof, more preferably at least one reinforcement is selected from the group consisting of cellulose fibres, aramid fibres, carbon fibres, glass fibres, carbon black, microcrystalline cellulose, non-woven glass fibre fabrics, woven aramid fibre fabrics, woven jute fibre fabrics, woven flax fibre fabrics, aramid fibre-phenolic honeycomb, glass fibre-phenolic honeycomb and mixtures thereof.

Examples of commercially available reinforcements for use in the present invention are but not limited to Acros Organics microcrystalline cellulose, Evonic Printex II carbon black, α-cellulose Sigma Aldrich powder, Procotex aramid fibre, Procotex CF-MLD100-13010 carbon fibres, E-glass Vetrotex textiles fibres EC9 134 z28 T6M ECG 37 1/0 0.7z, Unfilo® U809 Advantex® glass fiber, Composites Evolution Biotex jute plain weave, Composites Evolution Biotex flax 2/2 twill, Easycomposites aramid cloth fabric satin weave, Euro-composites ECG glass fibre-phenolic honeycomb, Euro-composites ECAI aramid fibre-phenolic honeycomb, Cel Components Alveolar PP8-80T30 3D structure, Cel Components Alveolar 3.5-90 3D structure.

Depending on the reinforcement incorporated into the hybrid aerogel according to the present invention, the reinforcement percentage in the final material may vary from 0.01% up to 30% based on the total weight of the initial solvent.

In one embodiment, a particle reinforcement such as carbon black is used and the amount added to the material is less than 0.1% based on the total weight of the initial solvent.

In another embodiment, a fibre reinforcement such as glass fibre fabrics are included in the hybrid aerogel, and the amount added to the material is up to 30% based on the total weight of the initial solvent.

In another embodiment, a 3D structure such as an aramid fibre/phenolic honeycomb is incorporated into the material as a reinforcement. The amount is around 4% based on the total weight of the initial solvent.

A hybrid aerogel according to the present invention has a solid content from 3 to 30% based on the weight of the initial solvent, preferably from 5 to 20%. This is appropriate solid content range to obtain a good compromise between thermal and mechanical performance.

A hybrid aerogel according to the present invention has a thermal conductivity less than 80 mW/m·K, preferably less than 60 mW/m·K, more preferably less than 40 mW/m·K, wherein said thermal conductivity is measured by means of the C-Therm TCi.

In order to have a high performance insulating material it is very important to have as low thermal conductivity value as possible.

Thermal conductivity can be measured by using diffusivity sensor method as described below.

Diffusivity Sensor Method—

In this method, the thermal conductivity is measured by using a diffusivity sensor. In this method, the heat source and the measuring sensor are on the same side of the device. The sensors measure the heat that diffuses from the sensor throughout the materials. This method is appropriate for lab scale tests.

A hybrid aerogel according to the present invention has a compression Young's modulus more than 0.1 MPa, preferably more than 15 MPa, and more preferably more than 30 MPa, wherein Compression Young Modulus is measured according to the method ASTM D1621.

A hybrid aerogel according to the present invention has preferably a compressive strength more than 0.01 MPa, more preferably more than 0.45 MPa, and even more preferably more than 3 MPa. Compressive strength is measured according to the standard ASTM D1621.

A hybrid aerogel according to the present invention has preferably a specific surface area ranging from 10 m²/g to 300 m²/g. Surface area is determined from N₂ sorption analysis at −196° C. using the Brunauer-Emmett-Teller (BET) method, in a specific surface analyser Quantachrome-6B. High surface area values are preferred because they are indicative of small pore sizes, which may be an indication of low thermal conductivity values.

A hybrid aerogel according to the present invention has preferably an average pore size ranging from 5 to 50 nm. Pore size distribution is calculated from Barret-Joyner-Halenda (BJH) model applied to the desorption branch from the isotherms measured by N₂ sorption analysis. Average pore size was determined by applying the following equation: Average pore size=(4*V/SA) wherein V is total pore volume and SA is surface area calculated from BJH. Porosity of the samples can also be evaluated by He picnometry.

Aerogel pore size below the mean free path of an air molecule (which is 70 nm) is desired, because that allows obtaining high performance thermal insulation aerogels having very low thermal conductivity values.

The present invention also relates to a method for preparing a hybrid aerogel. The gel network forms due to the crosslinking of the starting monomers, the supramolecular interactions between the polymer chains and the chemical linkages between the silanol groups at the surface of the clay and the functional groups of the isocyanate, forming urethane moieties. Upon gelation of the system, the solvent is contained in the pores of the gel. Therefore, only adequately balanced interactions between the three chemical species described above will lead to the desired structure.

The present invention relates to a method for preparing a hybrid aerogel comprising the steps of:

1) adding a clay into a solvent and mixing at high shear rates;

2) adding an isocyanate and mixing;

3) adding a catalyst if present, and mixing;

4) letting the mixture stand in order to form a gel;

5) washing said gel with a solvent; and

6) drying said gel by supercritical drying or ambient drying.

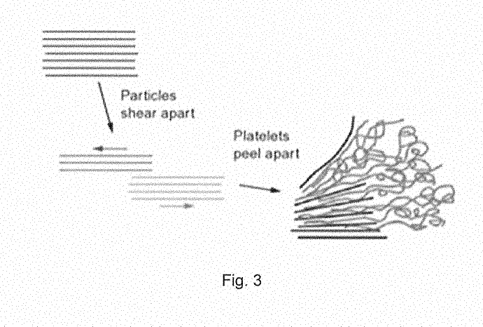

According to the present invention, to achieve the ideal hybrid network formed by the reaction between the silanol groups located at the surface of the clay and isocyanate groups, the clays must be delaminated prior to the reaction. Delamination allows the silanol groups confined in-between the agglomerated platelets to react with isocyanates. Therefore, dispersion and delamination is a key step during the process according to the present invention in order to achieve the final hybrid aerogel. Moreover, when a high degree of delamination is achieved, the enhancement in the properties of the final material due to the presence of clays, is observed. Dispersion methods implying high shear forces and a good compatibility between the selected clay and the solvent will provide good dispersions where no, or very low, clay sedimentation and high degree of delamination are achieved. High shear forces may be obtained at a stirring rate of greater than 1500 rpm, preferably greater than 3000 rpm. FIG. 3 illustrates the delamination of the clays in step 1 when dispersed in a compatible solvent.

When clay delamination is obtained, large amounts of silanol groups at the surface of each platelet will be available to react in a second step with a crosslinker, such as isocyanates. Only in these cases, the 3D network can be formed. In addition, a good clay dispersion in a solvent, leads to a better interaction with the isocyanate, and therefore, more homogeneous hybrid clay-aerogel material is achieved.

Once the clay has been properly dispersed and delaminated in the proper solvent, the hydroxyl groups are free to react with other functional groups. In the present invention, the hydroxyl groups react with isocyanates in the step two, forming a mainly polyurethane network.

The catalyst is added to the reaction mixture in step three, if the catalyst is used.

Gelation step, step four, is carried out for the pre-set time and temperature. Preferably, temperature is set on step four, more preferably, temperature from 0° C. to 50° C. is applied while gel is forming. Even more preferably, temperature from 10 to 40° C. is applied, and most preferably, temperature from 15° C. to 30° C. is applied. Temperatures from 0° C. to 50° C. are preferred because of short gelling times.

Gelation time is preferably from 0 to 72 hours, more preferably from 0.25 to 12 hours and even more preferably from 0.25 to 6 hours.

The solvent of wet gels is changed one or more times after the gelation in step five. The washing steps are done gradually, and if required, to the preferred solvent for the drying process.

In one embodiment, the washing steps are done gradually as follows: 1) acetone; 2) acetone/hexane 3:1; 3) acetone/hexane 1:1; 4) acetone/hexane 1:3 and 5) hexane.

Washing time is preferably from 12 hours to 96 hours in step five, preferably from 24 hours to 72 hours.

The supercritical state of a substance is reached once its liquid and gaseous phases become indistinguishable. The pressure and temperature at which the substance enters this phase is called critical point. In this phase, the fluid presents the low viscosity of a gas, maintaining the higher density of a liquid. It can effuse through solids like a gas and dissolve materials like a liquid. Considering an aerogel, once the liquid inside the wet gel pores reaches the supercritical phase, its molecules do not possess enough intermolecular forces to create the necessary surface tension that creates capillarity stress. Hence, the gel can be dried, minimizing shrinkage and possible collapse of the gel network.

Once the wet gel remains in the proper solvent, it is dried in supercritical (CO₂) or ambient conditions in step six obtaining an aerogel material. When the replacing solvent is acetone, the obtained gels are dried in CO₂, whereas if the replacing solvent is hexane, the obtained gels are dried at ambient conditions.

The drying process at supercritical conditions is performed by exchanging the solvent in the gel with CO₂ or other suitable solvents in their supercritical state. Due to this, capillary forces exerted by the solvent during evaporation in the nanometric pores are minimized and shrinkage of the gel body can be reduced.

In one embodiment, the method for preparing the hybrid aerogel involves the recycling of the CO₂ from the supercritical drying step.

Alternatively, wet gels can be dried at ambient conditions, in which the solvent is evaporated at room temperature. However, as the liquid evaporates from the pores, it can create a meniscus that recedes back into the gel due to the difference between interfacial energies. This may create a capillary stress on the gel, which responds by shrinking. If these forces are strong enough, they can even lead to the collapse or cracking of the whole structure. However, there are different possibilities to minimize this phenomenon. One practical solution involves the use of solvents with low surface tension to minimize the interfacial energy between the liquid and the pore. Hexane is usually used as a convenient solvent for ambient drying, as its surface tension is one of the lowest among the conventional solvents. Unfortunately, not all the solvents lead to gelation, which means that some cases would require the exchange of solvent between an initial one required for the gel formation and a second one most appropriate for the drying process.

Hybrid aerogels according to the present invention can be used as a thermal or acoustic insulating material.

Hybrid aerogels according to the present invention may be used in a variety of applications such as building construction, electronics or for the aerospace industry. Hybrid aerogels according to the present invention can be used as thermal insulating material for refrigerators, freezers, automotive engines and electronic devices. In addition, the hybrid aerogels according to the present invention can be used as a sound absorption material and a catalyst support.

Hybrid aerogels according to the present invention can be used for thermal insulation in different applications such as aircrafts, space crafts, pipelines, tankers and maritime ships replacing currently used foam panels and other foam products, in car battery housings and under hood liners, lamps, in cold packaging technology including tanks and boxes, jackets and footwear and tents.

Hybrid aerogels according to the present invention can also be used in construction materials due to their lightweight, strength, ability to be formed into desired shapes and superior thermal insulation properties.

Hybrid aerogels according to the present invention can be also used for storage of cryogens.

Hybrid aerogels according to the present invention can be also used as an adsorption agent for oil spill clean-up, due to their high oil absorption rate.

Hybrid aerogels according to the present invention can be also used in safety and protective equipment as a shock-absorbing medium.

The present invention also relates to a thermal or an acoustic insulating material comprising hybrid aerogels according to the present invention.

### EXAMPLES

### Example 1

Hybrid Aerogel Using a Non-Modified Clay by Ambient Drying

The synthesis consisted two steps. In the first step, 20 mL of solvent (acetone or toluene) was poured in a polypropylene speed mixer cup (50 mL), followed by the addition of a non-modified clay (Optigel CL, 3 wt % from BYK) and 20 phr of the grinding ceramic beads (Zirmyl Y from Saint-Gobain) in order to introduce shear while mixing. The mixture was stirred for three minutes at 3500 rpm.

In the second step, the ceramic beads were removed from the dispersion and 10 wt % of aliphatic polyisocyanate Desmodur N3300 (from Bayer) was added. The reactants were mixed using the speed mixer for 3 minutes at 3500 rpm. The final dispersion was left to gel in the same recipient. Once the samples were gelled, the washing steps needed to be done in order to proceed with the sample drying.

In order to dry the sample via ambient evaporation, a solvent exchange was performed with 40 mL of a mixture of the organic solvent used (acetone or toluene) and hexane (1:0.25) in volume, respectively. After 24 h, the mixture was replaced by the same mixture on a 1:1 ratio. After 24 h, the solvent was replaced by the final mixture on a 0.25:1 ratio in volume. Followed by the last washing step, which was done with a 100% of hexane. Subsequently, the sample was left to dry at room conditions. Table 1 illustrates results regarding density, thermal conductivity and linear shrinkage of the obtained aerogel.

TABLE 1

| | Density | Thermal conductivity | Linear |
|---|---|---|---|
| Solvent | (g/cm³) | (mW/m · K) | shrinkage (%) |
| Acetone | 0.250 | 54 | 5 |

### Example 2

Hybrid Aerogel Using an Organically-Modified Clay in Supercritical Drying

The synthesis consisted two steps. In the first step, 20 mL of solvent (acetone or toluene) was poured in a polypropylene speed mixer cup (50 mL), followed by the addition of the corresponding an organically-modified clay (Tixogel VZ, 3 wt %) and 20 phr of the grinding ceramic beads (Zirmyl Y) in order to introduce shear while mixing. The mixture was stirred for three minutes at 3500 rpm.

In the second step, the ceramic beads were removed from the dispersion and a 10 wt % of the aliphatic polyisocyanate Desmodur N3300 (from Bayer) was added. The reactants were mixed using the speed mixer for 3 minutes at 3500 rpm. The final dispersion was left to gel in the same recipient. Once the samples were gelled, the washing steps needed to be done in order to proceed with the drying of the sample were performed.

The samples were dried using supercritical conditions. For the hybrid aerogels prepared in acetone, the samples were washed for 24 h in fresh acetone three times, with the double amount of the solvent which was used in the preparation of the gel. In the case of the samples were prepared in toluene, a solvent exchange procedure was performed following the same methodology used in the solvent exchange of the samples to dry via ambient drying. The only difference was that they were performed with mixtures of toluene-acetone, instead of toluene-hexane. Subsequently, the samples were dried on the inside of a reactor, under supercritical conditions of CO₂. Table 2 illustrates the results regarding density, thermal conductivity and compression Young modulus of the obtained aerogel.

TABLE 2

| | | Thermal conductivity | Compression Young |
|---|---|---|---|
| Solvent | Density (g/cm³) | (mW/m · K) | Modulus (MPa) |
| Acetone | 0.175 | 47 | 5.9 |

### Example 3

Hybrid Aerogel Using a Catalyst

The aerogel was prepared by using the same mixing conditions described in Example 1. In order to decrease the gelling time, a catalyst (Triethylamine, 2 wt %) was added in the second step, maintaining the same mixing conditions. Once the samples were gelled, the washing steps needed to be done in order to proceed with the drying of the sample.

The drying procedures were identical to the ones described in Example 1 for ambient conditions and Example 2 for supercritical drying. Table 3 illustrates the results regarding density, thermal conductivity and compression Young modulus of the obtained aerogel.

TABLE 3

| | Density | Thermal conductivity | Compression Young |
|---|---|---|---|
| Catalyst | (g/cm³) | (mW/m · K) | Modulus (MPa) |
| Triethylamine | 0.178 | 53 | 0.3 |

### Example 4

Hybrid Aerogel Using Aromatic Polyisocyanates

The synthesis consisted two steps. In the first step, 20 mL of solvent (acetone or toluene) was poured in a polypropylene speed mixer cup (50 mL), followed by the addition of the corresponding an organically-modified clay (Tixogel VZ, 3 wt %) and 20 phr of the grinding ceramic beads (Zirmyl Y) in order to introduce shear while mixing. The mixture was stirred for three minutes at 3500 rpm.

In the second step, the ceramic beads were removed from the dispersion and a 10 wt % of the polyisocyanate Desmodur RE (from Bayer) was added, taking into account that the polyisocyanate (27%) was dissolved in ethyl acetate. The reactants were mixed using the speed mixer. The final dispersion was left to gel in the same recipient. Once the samples were gelled, the washing steps needed to be done in order to proceed with the drying of the sample were performed.

The drying procedures were identical to the ones described in Example 1 for ambient conditions and Example 2 for supercritical drying. Table 4 illustrates results regarding density, thermal conductivity, and linear shrinkage of the obtained aerogel.

TABLE 4

| | | | Thermal | |
|---|---|---|---|---|
| | | Density | conductivity | Linear shrinkage |
| Solvent | Drying process | (g/cm³) | (mW/m · K) | (%) |
| Toluene | Ambient drying | 0.17 | 39 | 11.5 |

### Example 5

Hybrid Aerogel with Different Clay Loadings

The synthesis consisted two steps. In the first step, 20 mL of solvent (acetone or toluene) was poured in a polypropylene speed mixer cup (20 mL), followed by the addition of the corresponding clay (1, 2, 5, 10 wt %) and 20 phr of the grinding ceramic beads (Zirmyl Y) in order to introduce shear while mixing. The mixture was stirred during three minutes at 3500 rpm.

In the second step, the ceramic beads were removed from the dispersion and a 10 wt % of the corresponding polyisocyanate (Desmodur N3300 from Bayer) was added. The reactants were mixed using the speed mixer for 3 min at 3500 rpm. The final dispersion was left to gel in the same recipient. Once the samples were gelled, the washing steps needed to be done in order to proceed with the drying of the sample were performed.

The drying procedures were identical to the ones described in Example 1 for ambient conditions and Example 2 for supercritical drying. Table 5 illustrates the results regarding density, thermal conductivity and linear shrinkage of the obtained aerogel.

TABLE 5

| | | | | Thermal | Linear |
|---|---|---|---|---|---|
| | Drying | Clay type | Density | conductivity | shrinkage |
| Solvent | process | and loading | (g/cm³) | (mW/m · K) | (%) |
| Acetone | SCD | Tixogel VZ, | 0.294 | 49 | 15 |
| | | 10 wt % | | | |

### Example 6

Hybrid Aerogel Using a Mixture of an Organically-Modified Bentonite and a Sepiolite in Supercritical Drying

The synthesis consisted two steps. In the first step, 20 mL of solvent (acetone or toluene) was poured in a polypropylene speed mixer cup (50 mL), followed by the addition of the corresponding a mixture of an organically-modified bentonite and a sepiolite (Garamite 1958, 3 wt %) and 20 phr of the grinding ceramic beads (Zirmyl Y) in order to introduce shear while mixing. The mixture was stirred for three minutes at 3500 rpm.

In the second step, the ceramic beads were removed from the dispersion and a 10 wt % of the aliphatic polyisocyanate Desmodur N3300 (from Bayer) was added. The reactants were mixed using the speed mixer 3 min at 3500 rpm. The final dispersion was left to gel in the same recipient. Once the samples were gelled, the washing steps needed to be done in order to proceed with the drying of the sample were performed.

The samples were dried using supercritical conditions. The drying procedures were identical to the ones described Example 2. Table 6 illustrates the results regarding density, thermal conductivity, compression Young modulus and linear shrinkage of the obtained aerogel.

TABLE 6

| | | | Thermal | Linear | Compression |
|---|---|---|---|---|---|
| | Drying | Density | conductivity | shrinkage | Young Modulus |
| Solvent | process | (g/cm³) | (mW/m · K) | (%) | (MPa) |
| Acetone | SCD | 0.149 | 42 | 16 | 3.6 |

### Example 7

Hybrid Aerogel Obtained Employing a Different Dispersion Method (Stator Rotor)

The synthesis consists of two steps. In the first step, 20 ml of dispersion of the corresponding organically-modified clay (Tixogel VZ, 3 wt %) in the solvent (acetone) were prepared. The mixture was processed for 15 minutes at 1500 rpm, using the LabStar LMZ rotatory stator from Netzsch.

In the second step, 10 wt % of the aliphatic polyisocyanate Desmodur N3300 (from Bayer) was added to the dispersion previously prepared. The reactants were gently mixed employing magnetic stirring (300 rpm for 3 min) in order to avoid foaming. The reaction mixture was then poured into sealed molds. Gelation occurred after 24 h hours, providing a white gel.

The samples were dried using supercritical conditions. The drying procedures were identical to the ones described Example 2. Table 7 illustrates the results regarding density, thermal conductivity and linear shrinkage of the obtained aerogel.

TABLE 7

| | | | Thermal | Linear | Compression |
|---|---|---|---|---|---|
| | Drying | Density | conductivity | shrinkage | Young Modulus |
| Solvent | process | (g/cm³) | (mW/m · K) | (%) | (MPa) |
| Acetone | SCD | 0.184 | 43 | 27 | 8.5 |

### Example 8

Hybrid Aerogel with a Honeycomb Core as Reinforcement

The gels were prepared by using the same mixing conditions described in Example 6. Garamite 1958 was used as a clay (3 wt %), aliphatic polyisocyanate Desmodur N3300 (Bayer) as a starting reactant (10 wt %) and acetone as a solvent.

Once the reactants were dispersed, the reinforcement, a honeycomb core based on aramid fibre and phenolic resin was incorporated. The solution was left to gel and dried by supercritical drying, as described in Example 6. Table 8 illustrates the results regarding density, thermal conductivity and linear shrinkage of the obtained aerogel.

TABLE 8

| | | | Thermal | Linear | Compression |
|---|---|---|---|---|---|
| | Drying | Density | conductivity | shrinkage | Young Modulus |
| Solvent | process | (g/cm³) | (mW/m · K) | (%) | (MPa) |
| Acetone | SCD | 0.158 | 39 | 4 | 55.4 |

### Example 9

Hybrid Aerogel with Cellulose Fibres as Reinforcement

The hybrid aerogels were prepared by using Tixogel VZ (3 wt %) as a clay, polyisocyanate Desmodur N3300 (10 wt %) as a starting reactant, and acetone as a solvent. Cellulose fibres (0.1 wt % based on the total weight of the initial solvent) were incorporated in the system as reinforcement in order to increase the mechanical properties of the material.

The gels were prepared by pouring 20 mL of acetone in a polypropylene speed mixer cup (50 mL), followed by the addition of Tixogel and 20 phr of the grinding ceramic beads (Zirmyl Y). The mixture was stirred for three minutes at 3500 rpm. The cellulose fibres were added and the system was stirred for three minutes at 3500 rpm. The ceramic beads were removed and the Desmodur N3300 (from Bayer) was added and mixed for 3 minutes at 3500 rpm. The solution was left to gel and dried by ambient drying, as described in Example 1. Table 9 illustrates results regarding density, thermal conductivity and linear shrinkage of the obtained aerogel.

TABLE 9

| | | | Thermal | Linear | Compression |
|---|---|---|---|---|---|
| | Drying | Density | conductivity | shrinkage | Young Modulus |
| Solvent | process | (g/cm³) | (mW/m · K) | (%) | (MPa) |
| Acetone | AD | 0.267 | 58 | 30 | 4.61 |

Hybrid aerogels according to the present invention show densities in the range of 0.1 to 0.3 g/cm³ and a compression moduli from 0.2 MPa up to 56 MPa. Thermal conductivity of the hybrid aerogels can be measured by means of a diffusivity method. Hybrid aerogels show thermal conductivity coefficients in the range of 38 up to 60 mW/m K.

What is claimed is:

1. An aerogel obtained by reacting an isocyanate compound and silanol moieties on a surface of a clay in a presence of a solvent, wherein said isocyanate compound is an aromatic isocyanate compound or an aliphatic isocyanate compound selected from the group consisting of 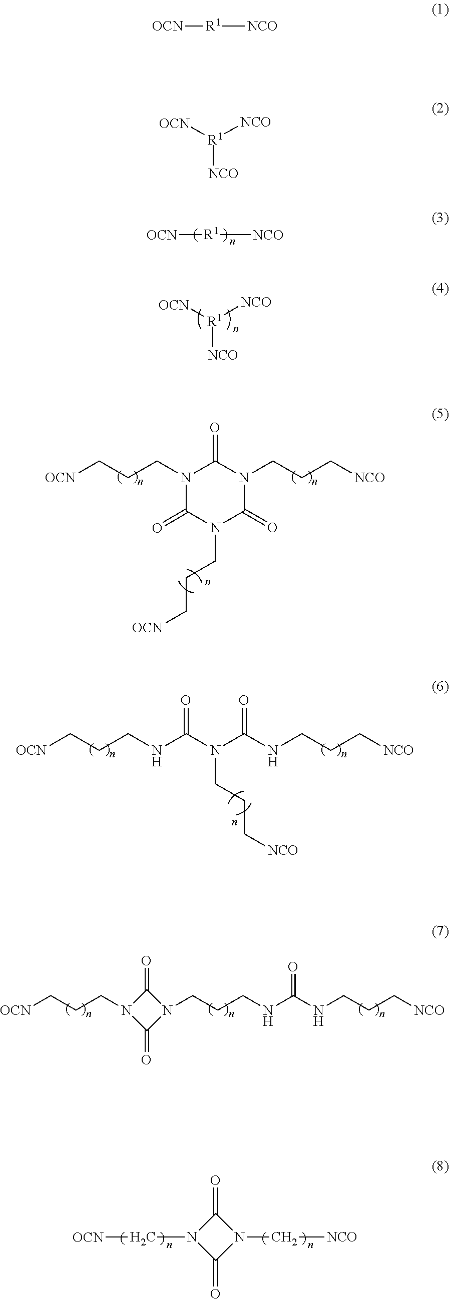
wherein R¹ is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and an integer n is from 1 to 30; 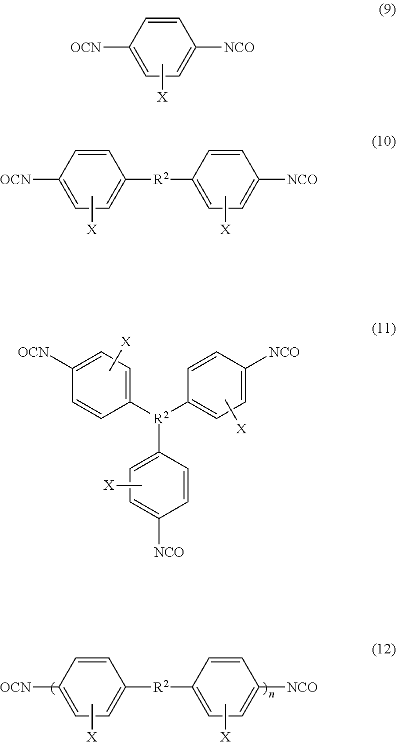
wherein X represents a substituent, or different substituents and are selected independently from the group consisting of hydrogen, halogen and linear or branched C1-C6 alkyl groups, attached on their respective phenyl ring at the 2-position, 3-position or 4-position, and their respective isomers, and R² is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3 to C30 heterocycloalkyl group and a substituted or unsubstituted C1-C30 heteroalkyl group from and a combination of thereof; and an integer n is from 1 to 30; 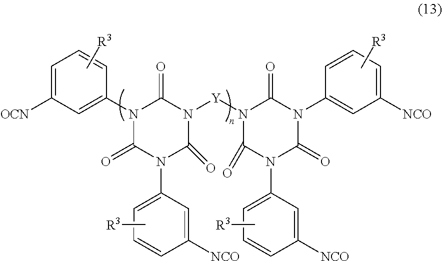
wherein R³ is selected independently from the group consisting of alkyl, hydrogen and alkenyl, and Y is selected from the group consisting of 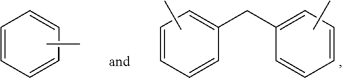
and n is an integer from 0 to 3; 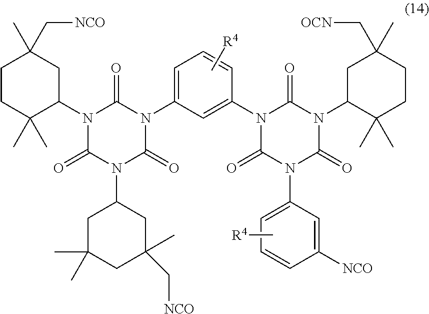
wherein R⁴ is selected independently from the group consisting of alkyl, hydrogen and alkenyl.

2. An aerogel according to claim 1, wherein said isocyanate compound and said clay are reacted in the presence of a catalyst.

3. An aerogel according to claim 1, wherein said clay is phyllosilicate mineral species, preferably selected from the group consisting of 2:1 laminar silicates, and more preferably from the subgroup of montmorillonite or sepiolite and mixtures thereof.

4. An aerogel according to claim 1, wherein said isocyanate is selected from the group consisting of 1,3,5-Tris(6-isocyanatohexyl)-1,3,5-triazinane-2,4,6-trione, 6-[3-(6-isocyanatohexyl)-2,4-dioxo-1,3-diazetidin-1-yl]hexyl N-(6-isocyanatohexyl) carbamate, methylene diphenyl diisocyanate, 1,6-diisocyanatohexane, 1-[bis(4-isocyanatophenyl)methyl]-4-isocyanatobenzene, 2,4-diisocyanato-1-methyl-benzene, oligomers of the above-mentioned and mixtures thereof.

5. An aerogel according to claim 1, wherein isocyanate content is from 1 to 60% by weight of the weight of the initial solvent, preferably from 2 to 40% and more preferably from 5 to 25%.

6. An aerogel according to claim 1, wherein clay content is from 0.5 to 30% by weight of the weight of the initial solvent, preferably from 0.5 to 20% and more preferably from 0.5 to 10%.

7. An aerogel according to claim 1, wherein said solvent is selected from the group consisting of a polar aprotic solvent, a non-polar solvent and mixtures thereof.

8. An aerogel according to claim 1, wherein said catalyst is selected from the group consisting of alkyl amines, aromatic amines, imidazole derivatives, tin derivatives, aza compounds, guanidine derivatives, amidines and mixtures thereof.

9. An aerogel according to claim 1, wherein catalyst content is from 0.01 to 20% by weight of the total weight of the initial solvent, preferably from 0.1 to 15% and more preferably from 0.1 to 5%.

10. An aerogel according to claim 1, wherein said aerogel further comprises at least one reinforcement, wherein said reinforcement is selected from the group consisting of fibres, particles, non-woven and woven fibre fabrics, 3D structures and mixtures thereof.

11. An aerogel according to claim 1, wherein said aerogel has a solid content from 3 to 30% based on the weight of the initial solvent, preferably from 5 to 20%.

12. An aerogel according to claim 1, wherein said aerogel has a thermal conductivity less than 80 mW/m·K, preferably less than 60 mW/m·K, more preferably less than 40 mW/m·K, wherein said thermal conductivity is measured by means of the C-Therm TCi.

13. An aerogel according to claim 1, wherein said aerogel has a compressive Young's modulus more than 0.1 MPa, preferably more than 15 MPa, and more preferably more than 30 MPa, wherein Compression Young Modulus is measured according to the method ASTM D1621.

14. A method for preparing an aerogel according to claim 1 comprising the steps of:
1) adding a clay into a solvent and mixing at high shear rates;
2) adding an isocyanate and mixing;
3) adding a catalyst if present, and mixing;
4) letting the mixture to stand in order to form a gel;
5) washing said gel with a solvent; and
6) drying said gel by supercritical drying or ambient drying.

15. A thermal insulating material or an acoustic insulating material comprising an aerogel according to claim 1.

16. Use of an aerogel according to claim 1 as a thermal insulating material or acoustic insulating material.

17. Use of an aerogel according to claim 16 as a thermal insulating material for the storage of cryogens.
